(19) United States
(12) Patent Application Publication
(10) Pub. No.: US 2015/0019255 A1
(43) Pub. Date: Jan. 15, 2015

(54) SYSTEMS AND METHODS FOR PRIMARY ADMISSIONS ANALYSIS

(71) Applicant: Health Dialog Services Corporation, Boston, MA (US)

(72) Inventor: Henriette Coetzer, Idstone (GB)

(21) Appl. No.: 13/940,971

(22) Filed: Jul. 12, 2013

(51) Int. Cl. G06Q 50/24; G06Q 10/06

(52) U.S. Cl. CPC G06Q 50/24; G06Q 10/0639
USPC 705/3

(57) ABSTRACT

An admission analytic engine may search health care records to identify health care providers associated with unnecessary or preventable inpatient admissions based on clinical indicators. Identifying relationships between health care providers and unnecessary or preventable inpatient admissions allows generation of reports highlighting the strengths and weaknesses of the health care providers. Identifying the relationships also allows the admission analytic engine to identify a health care provider accountable for an unnecessary or preventable inpatient admission.

### BACKGROUND

Inpatient admissions are medical interventions requiring a patient to stay in a facility overnight or longer. Inpatient admissions are time-consuming for both patients and physicians, and may expose patients to additional risks, including hospital-acquired infections and clinical errors. Consequently, a health care provider may be judged in part on their ability to minimize patients' need for inpatient treatment. At the same time, different health care providers may serve different populations, and thus a direct comparison of health care providers' inpatient admission rates may not adequately capture the benefit provided by a health care provider.

There is therefore a need for improved inpatient admission evaluation applications.

### SUMMARY

Accordingly, the systems and methods described herein relate to evaluating health care provider performance based on the provider's association with index admissions. A health care provider provides health care to patients, and may be a physician, a nurse practitioner, a physical therapist, a medical practice, a clinic, a hospital, or some other suitable health care provider. An index admission is a patient's initial admission to an inpatient treatment facility for care associated with a health problem. As an illustrative example, if a patient is admitted for heart surgery, and two days later is admitted for an unrelated matter such as cataract removal, both admissions may be considered index admissions. In certain implementations, index admissions may be distinguished by time. As an illustrative example, if a patient is admitted for heart surgery and readmitted three weeks later due to complications directly associated with the heart surgery, such as endocarditis, only the initial admission may be identified as an index admission. In this example, although the latter admission is an inpatient admission, it may have been caused by the initial admission, and is thus part of a single program of care for the problem that gave rise to the heart surgery rather than a distinct index admission. Alternatively, if a patient is admitted for heart surgery, and is admitted for another heart surgery ten years later, both admissions may be considered as index admissions even if the same problem gave rise to both admissions. An index admission may potentially be unnecessary, preventable, or appropriate, and may be identified as such based on an interaction code. An interaction code may be a string of characters representing one or more of a diagnosis of a patient's medical problems, a treatment received by the patient, medications taken by the patient, test results for the patient, and other indicators of a patient's medical issues.

An unnecessary admission, as the term is employed herein, may be an index admission related to a health problem that, according to accepted standards of care, more likely than not, may be safely treated outside of an inpatient facility. In some implementations, the need for an admission may be determined based on one or more factors, which may include differences between outcome metrics for patients in an inpatient setting and patients in an outpatient setting. Such outcome metrics may include clinical outcomes, functional outcomes, patient satisfaction, patient recovery time, or other appropriate metrics. A health care provider may be associated with an unnecessary admission based on whether the health care provider allowed the unnecessary admission, caused the unnecessary admission, or was treating the health care problem associated with the unnecessary admission. As illustrative examples, one unnecessary admission may be associated with the hospital that admits the patient, another with a practice that did not provide adequate after-hours access or self-care instructions, and a third with a physician who referred a patient for inpatient treatment of a problem that does not require inpatient treatment.

A preventable admission, as the term is employed herein, may be an index admission related to a health problem which, according to accepted standards of care, would have been less likely to occur if a health care provider had made an earlier intervention outside of the inpatient setting. In some implementations, an index admission may be considered preventable only if the earlier intervention would have had more than a predetermined effect on the risk of admission. A health care provider may be associated with a preventable admission based on whether the health care provider had control over certain elements of care that may have affected the patient's risk of having the preventable admission. As an illustrative example, if a patient is hospitalized for a severe allergic reaction to an unnecessary medication, the admission may be preventable and a physician who gave the patient the unnecessary prescription may be considered associated with the preventable admission. As another illustrative example, amputations performed on diabetic patients may often be prevented by maintaining optimal blood sugar levels and controlling vascular risks through regular monitoring and prescription of appropriate medication. As such, a primary care physician who provides oversight and coordinates the care associated with a patient's diabetes may be considered associated with a diabetes-related amputation performed on one of the physician's patients. But in the same example, as psychiatrists are not responsible for the continual or critical care of diabetics, the same patient's psychiatrist may not be associated with the amputation. A patient's preventable admission is associated with the patient's health problem, and the health care providers who provide a critical or continual element of care associated with managing the patient's health problem are consequently associated with the preventable admission.

As the terms are employed herein, preventable admissions and unnecessary admissions are identified on the basis of one or more predetermined factors, which may include diagnoses of the patient's health problems, medications being taken by the patient, or other suitable indicators. As both preventable admissions and unnecessary admissions are varieties of index admissions, systems and methods described herein that make analyses based on one or more preventable admissions may also or alternatively make analyses based on one or more unnecessary admissions, and vice-versa.

An appropriate admission, as the term is employed herein, is an index admission related to a health problem that does not meet the criteria identifying an unnecessary admission nor the criteria identifying a preventable admission.

Association between a health care provider and an index admission may be based on one or more of whether the health care provider is associated with the admitted patient, the length of time between a health care provider's interaction with the patient and the index admission, the health problem or problems associated with the index admission and the health care provider's type, or other suitable criteria. Such criteria may be based on clinical best practices, on correlations identified from medical records, or on some other suitable basis.

A health care provider associated with an unnecessary or preventable admission may be responsible for the unnecessary or preventable admission. As the term “responsible” is employed herein, a health care provider may be responsible for such an admission if the provider is associated with the admission and provided or could have provided the patient with care that may have affected the risk for the admission occurring. Responsibility for an admission therefore encompasses not only direct causation of an admission, but ability to make limited changes to the probability of an admission. As an illustrative example, a senior residential care facility may be able to reduce, but not eliminate, the risk of its residents contracting influenza. As the facility can reduce the risk of influenza, the facility may be considered responsible for failing to prevent an influenza-related preventable admission, in some implementations even if the facility took steps to reduce the risk of residents contracting influenza. More than one health care provider may be responsible for an admission. As an illustrative example, both a primary care physician and a senior residential care facility may be responsible for an influenza-related preventable admission if either could have provided an influenza vaccine to a patient.

A health care provider may be considered more or less responsible for an unnecessary or preventable admission based on the provider's effect on the risk of the unnecessary or preventable admission. As an illustrative example, a cardiologist may have a large influence on the risk of a preventable admission for a heart attack and a smaller influence on the risk of a preventable admission for kidney failure. In such an example, the cardiologist would therefore be considered more responsible for a preventable heart attack admission and less responsible for a preventable kidney failure admission. The health care provider most responsible for a preventable or unnecessary admission may be identified as accountable for the preventable or unnecessary admission. Like a responsible provider, an accountable provider may be accountable for a preventable or unnecessary admission without necessarily being identified as the health care provider with sole control over the risk for the admission occurring. Accountability for unnecessary or preventable admissions may be the basis for evaluating health care providers, rewarding health care providers, recommending best practices, distributing resources within a health care system, or other suitable tasks. Illustrative examples include comparing similar health care providers based on the number of preventable admissions for which the health care providers are responsible, providing a bonus to the health care provider accountable for the smallest number of unnecessary admissions within a class of health care providers, and providing training, finances, and other resources designed to reduce the number of preventable admissions for which a health care provider is accountable.

In certain implementations, the methods described herein evaluate health care provider performance. A computer may receive a set of inpatient treatment records, and, based on the set of inpatient treatment records, may identify a set of preventable admissions. For each preventable admission in the set of preventable admissions, the computer may identify a clinical history associated with the admission, wherein the clinical history for the preventable admission includes medical records associated with at least a predetermined period preceding the preventable admission and may include demographic or other attribute information such as age. For each preventable admission, the computer further identifies a set of health care providers from the clinical history based on one or more interaction codes associated with the preventable admission, calculates a preventable admission evaluation for each health care provider in the set of health care providers based on the one or more interaction codes associated with the preventable admission, and assigns accountability for the preventable admission to a health care provider based on both the associated interaction code and the preventable admission evaluation of the health care provider. The computer further generates a report based on the preventable admission evaluation of each health care provider.

In some implementations, the computer may also or alternatively identify a set of unnecessary admissions. For each unnecessary admission in the set of unnecessary admissions, the computer may identify a clinical history associated with the unnecessary admission, wherein the clinical history for the unnecessary admission includes medical records associated with at least a predetermined period preceding the unnecessary admission. For each unnecessary admission, the computer further identifies a set of health care providers from the clinical history based on one or more interaction codes associated with the unnecessary admission, calculates an unnecessary admission evaluation for each health care provider in the set of health care providers based on the one or more interaction codes associated with the unnecessary admission, and assigns accountability for the unnecessary admission to a health care provider based on both the associated interaction code and the unnecessary admission evaluation of the health care provider. The computer further generates a report based on the unnecessary admission evaluation of each health care provider.

In some implementations, the preventable or unnecessary admission evaluation of a health care provider may be a function of the number of preventable or unnecessary admissions associated with a predetermined set of interaction codes.

In some implementations, the set of health care providers associated with a preventable or unnecessary admission includes a first health care provider and a second health care provider. In such implementations, the computer may assign accountability for the preventable or unnecessary admission to the first health care provider in response to the first provider having a preventable or unnecessary admission evaluation greater than a threshold, and may assign accountability for the preventable or unnecessary admission to the second health care provider in response to the first provider having a preventable or unnecessary admission evaluation less than a threshold. In some such implementations, the threshold may be based on a preventable or unnecessary admission evaluation of a health care provider in a set of health care providers similar to the first health care provider, on characteristics of a patient associated with the preventable or unnecessary admission, or on some other suitable criteria.

In some implementations, a health care provider may be associated with more than one preventable or unnecessary admission evaluation.

In some implementations, the report may identify a care measure associated with the preventable or unnecessary admission evaluation and the health care provider.

In some implementations, the set of health care providers may include one or more of a physician, a physician practice group, a primary care center, a hospital, some other suitable health care provider, or some combination thereof.

In some implementations, the set of interaction codes may include diagnosis-related group (DRG) codes, Ninth Revision International Classification of Diseases (ICD-9) codes, Tenth Revision International Classification of Diseases (ICD-10) codes, COMMON PROCEDURAL TERMINOLOGY® (CPT) codes, SYSTEMATIZED NOMENCLATURE OF MEDICINE—CLINICAL TERMS® (SNOMED CT) codes, or some other suitable interaction codes.

In some implementations, a computer may identify a set of patients associated with a set of one or more health care providers and receive a set of treatment records associated with the set of patients. The computer may identify, based on the set of treatment records, a subset of patients that were admitted to an inpatient treatment facility within a predetermined period of receiving care associated with a health care provider of the set of health care providers. The computer may filter the subset of patients based on the set of treatment records to identify a set of preventable admissions associated with the set of health care providers, wherein each preventable admission in the set of preventable admissions is associated with one or more interaction codes. The computer may calculate a preventable admissions evaluation for each health care provider in the set of health care providers based on the set of preventable admissions, and identify an accountable health care provider for each preventable admission in the set of preventable admissions based on the associated interaction code and the preventable admissions evaluation of each health care provider in the set of health care providers. The computer may further generate a report on the preventable admissions evaluations of the set of health care providers. In some implementations, the computer may also or alternatively identify a set of unnecessary admissions associated with the set of health care providers, and perform the same actions with respect to the set of unnecessary admissions.

In another aspect, the systems described herein evaluate health care provider performance, and may include an aggregate patient information database, a diagnostic map, an evaluator, a provider database, and a report generator. The aggregate patient information database may store a set of medical records. The diagnostic map may identify relationships between at least one unnecessary or preventable admission and at least one health care provider associated with the unnecessary or preventable admission. The evaluator may identify a set of unnecessary or preventable admissions. For each unnecessary or preventable admission in the set of unnecessary or preventable admissions, the evaluator may further identify a clinical history associated with the unnecessary or preventable admission, wherein the clinical history associated with the unnecessary or preventable admission includes medical records associated with at least a predetermined period preceding the unnecessary or preventable admission. The evaluator may identify a set of health care providers from the clinical history based on one or more interaction codes associated with the admission and the diagnostic map. The evaluator may calculate an unnecessary or preventable admission evaluation for each health care provider in the set of health care providers based on the one or more interaction codes associated with the admission, and assign accountability for each unnecessary or preventable admission to a health care provider based on the associated interaction code and the unnecessary or preventable admission evaluation of the health care provider. The provider database may store one or more unnecessary and preventable admission evaluations for each health care provider in the set of health care providers, and the report generator may generate reports based on unnecessary or preventable admission evaluations of each health care provider.

In some implementations, the set of health care providers associated with an unnecessary or preventable admission includes a first and a second health care provider. In such implementations, the evaluator may further assign accountability for an unnecessary or preventable admission to the first health care provider in response to the first provider having an unnecessary or preventable admission evaluation greater than a threshold, and may assign accountability for the unnecessary or preventable admission to the second health care provider in response to the first provider having an unnecessary or preventable admission evaluation less than a threshold. In some such implementations, the threshold may be based on an unnecessary or preventable admission evaluation of a health care provider in a set of health care providers similar to the first health care provider, on characteristics of a patient associated with the preventable admission, or on some other suitable criteria.

### BRIEF DESCRIPTION OF THE DRAWINGS

The systems and methods described herein are set forth in the appended claims. However, for the purpose of explanation, several implementations are set forth in the following figures.

FIG. 1 is a block diagram of an admission analysis system, according to an illustrative implementation;

FIG. 2 is a block diagram of an admissions analytics engine, according to an illustrative implementation;

FIG. 3 is an interaction code translation chart, according to an illustrative implementation;

FIG. 4 is a block diagram of an exemplary computing device for performing any of the processes described herein;

FIG. 5 is a flow chart of a process for generating unnecessary or preventable admission evaluations;

FIG. 6 is a flow chart of a process for generating unnecessary or preventable admission evaluations, according to an illustrative implementation;

FIG. 7 is a flow chart of a process for assigning accountability for unnecessary or preventable admissions and for reporting unnecessary or preventable admission evaluations; and

FIG. 8 depicts an exemplary screenshot of a report made with the admissions analytics engine of FIG. 2.

### DETAILED DESCRIPTION

In the following description, numerous details are set forth for the purpose of explanation. However, one of ordinary skill in the art will realize that the implementations described herein may be practiced without the use of these specific details and that the implementations described herein may be modified, supplemented, or otherwise altered without departing from the scope of the invention.

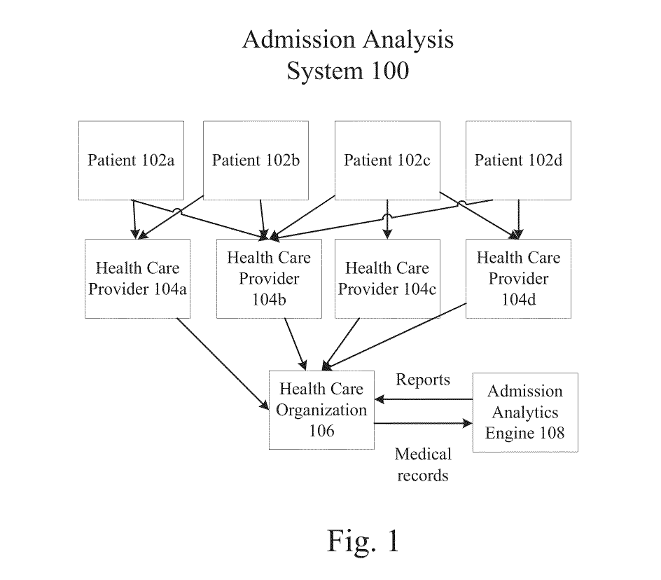

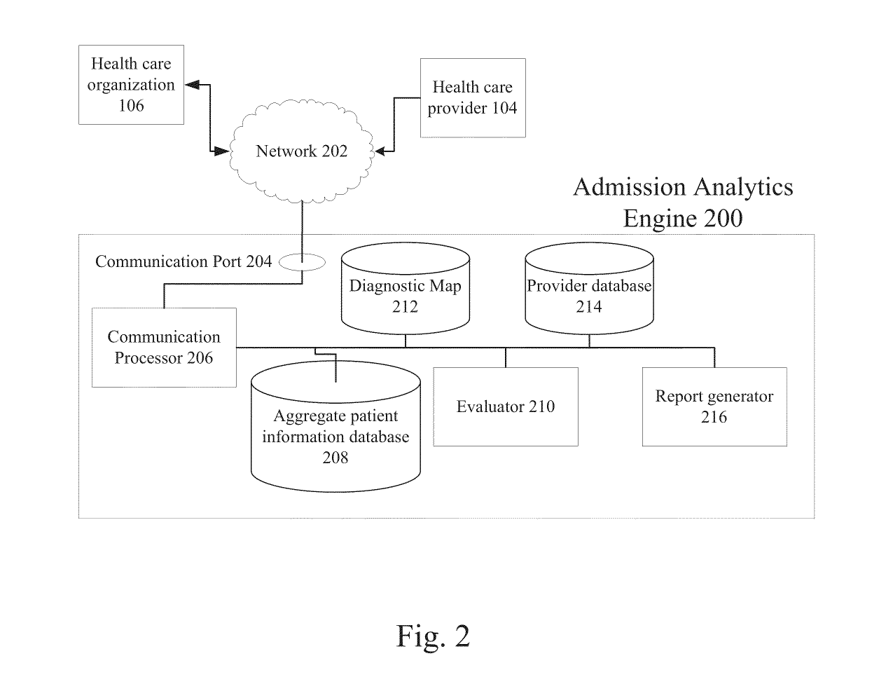

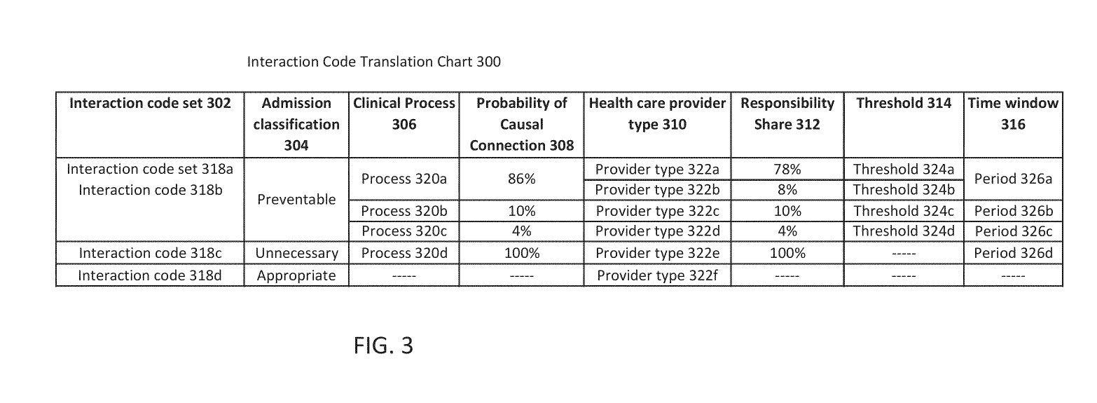

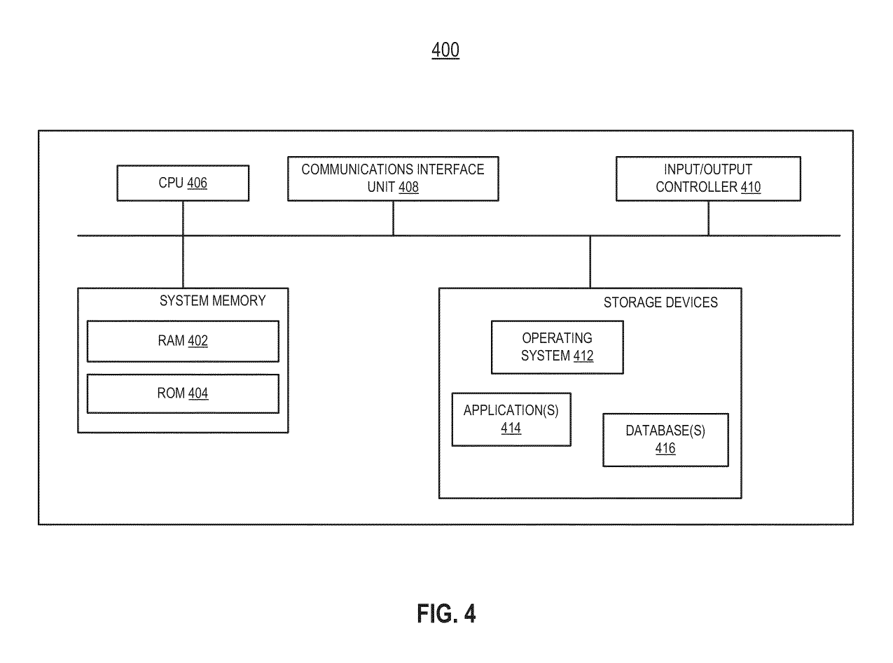

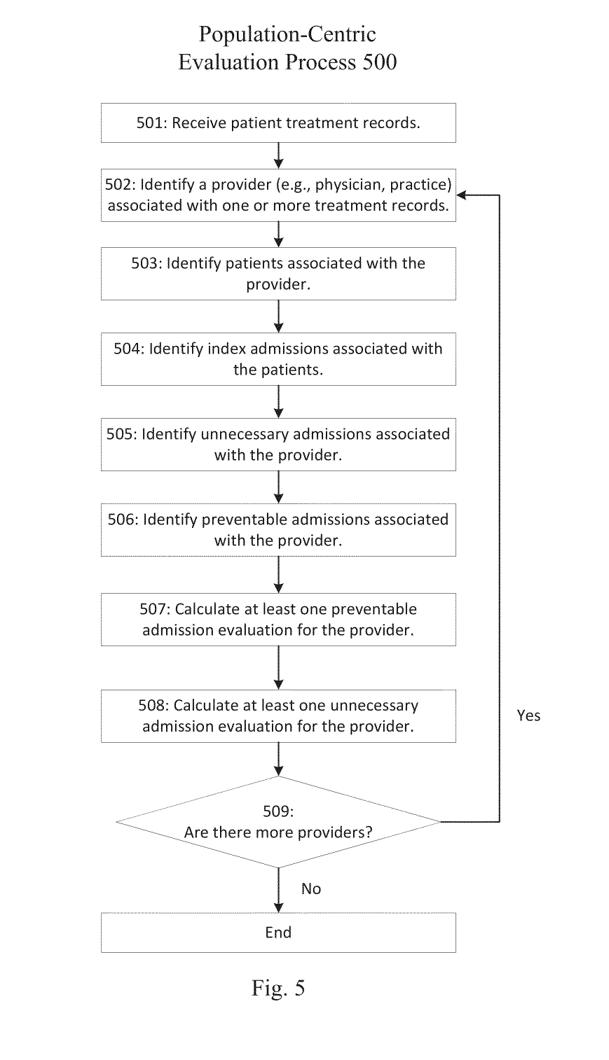

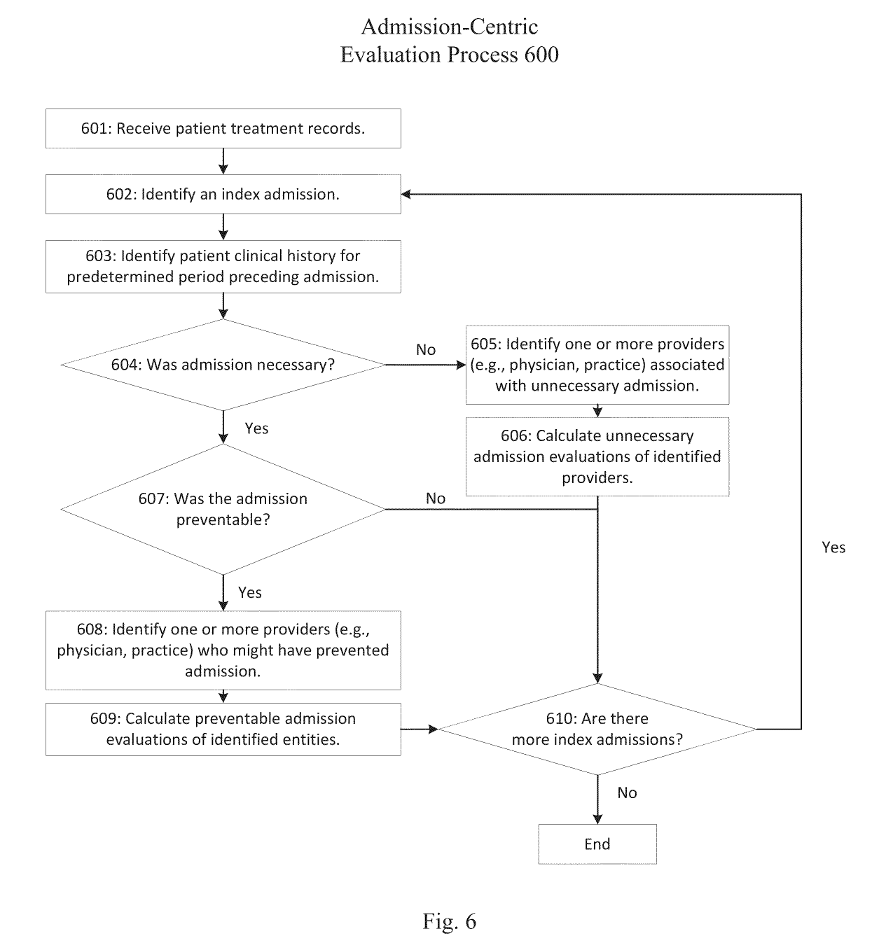

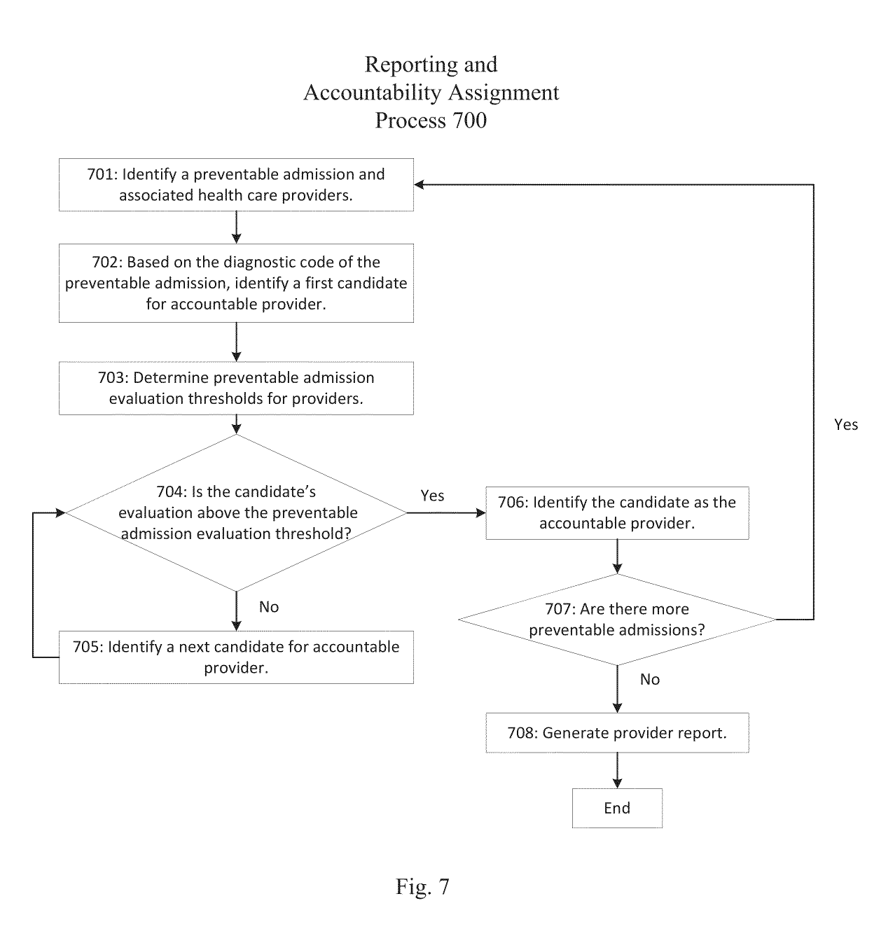

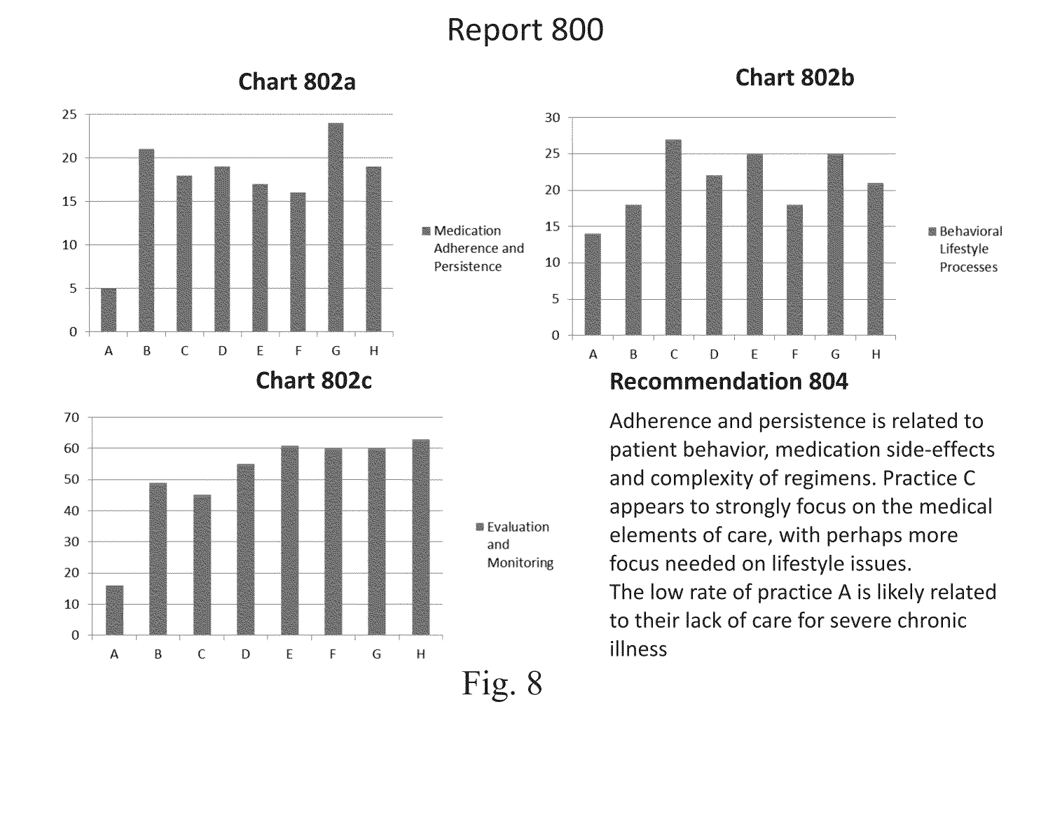

The systems and methods described herein relate to evaluating health care provider performance based on the number of preventable or unnecessary admissions each health care provider is associated with. A health care provider may be associated with a preventable admission if standards of care or suitable clinical evidence show that the health care provider may affect the risk that one of the provider's patients will have such a preventable admission. Health care providers may include individuals, groups, and facilities. An admission analytics engine may process clinical records to identify a set of preventable and unnecessary admissions and the health care providers associated with such admissions. The admission analytics engine may then use the identified set to calculate preventable and unnecessary admission evaluations for each health care provider. Accountability for such admissions may be assigned to a health care provider based on the health care provider's type and at least one of the health care provider's admission evaluations. Admission evaluations are further used to generate reports evaluating health care providers. FIG. 1 provides an overview of an exemplary system used to provide such evaluations. FIG. 2 describes in more detail an exemplary system to evaluate health care providers based on patients' clinical histories. FIG. 3 depicts a chart providing instructions for determining whether an inpatient admission is necessary or preventable, and, if so, how to identify accountable health care providers. FIG. 4 depicts a block diagram of a computing device that may make up one or more components of the systems described herein. FIG. 5 provides an exemplary method for generating preventable and unnecessary admission evaluations from population data. FIG. 6 provides an exemplary method for generating preventable and unnecessary admissions evaluations from admission data. FIG. 7 provides an exemplary method for assigning accountability for an admission to a health care provider and generating reports regarding the providers' evaluations. FIG. 8 provides a sample report such as is generated by the process described in relation to FIG. 7.

### General System Description

FIG. 1 is an illustrative block diagram of an admission analysis system 100, which processes medical records to evaluate health care provider performance. In system 100, patients 102a-102d (collectively, patients 102) may receive health care from one or more of health care providers 104a-104d (collectively, health care providers 104). Health care providers 104 may transmit billing information or other medical records to health care organization 106. Health care organization 106 transmits collected medical records to admission analytics engine 108. In some implementations, admission analytics engine 108 may also or alternatively receive medical records directly from patients 102 or health care providers 104. Admission analytics engine 108 processes the medical records to calculate a preventable admissions evaluation, an unnecessary admissions evaluation, or both for each health care provider 104. The calculated preventable or unnecessary admissions evaluations may serve as the basis for admission analytics engine 108 to generate reports regarding the performance of health care providers 104 and to identify a health care provider 104 accountable for a preventable or unnecessary admission.

A health care provider 104 provides health care to one or more patients 102, and may be a physician, a nurse practitioner, a physical therapist, a medical practice, a clinic, a hospital, or some other suitable health care provider. As depicted, health care provider 104a is an inpatient treatment facility, health care provider 104b is a physician, health care provider 104c is a physical therapist, and health care provider 104d is a senior care facility. In some implementations, health care providers 104 may differ from the depicted implementation in one or more of number and type without departing from the scope of the present disclosure. Each health care provider 104 transmits medical record information to health care organization 106, which may include claims for services, diagnoses, or other medical information associated with each patient 102 associated with the health care provider 104. In some implementations, such medical record information may be transmitted to health care organization 106 through a secure Internet connection, by fax, by mail, or by some other suitable medium.

In certain implementations, a health care organization 106 is an organization providing health insurance to some or all of patients 102, and may be a government health program, a health maintenance organization (HMO), an accountable care organization (ACO), a preferred provider organization (PPO), or some other suitable organization. Health care organization 106 may receive medical record information from health care providers 104, whether in connection with a claim or not, and in some implementations may also receive medical record information from one or more patients 102. Health care organization 106 transmits the medical record information to admission analytics engine 108, and may receive health care provider evaluations based on the medical record information on demand, when a health care provider fails to meet a predetermined standard of care, or under other predetermined conditions. Although only one health care organization 106 is depicted in FIG. 1, there may be a plurality of health care organizations 106 associated with one or more health care providers without departing from the scope of the present disclosure.

Admission analytics engine 108 may be a computer processor evaluating performance of health care providers 104 on the basis of medical record information received from health care organization 106, or, in some implementations, from health care providers 104 or patients 102. As described in relation to FIGS. 2, 5, and 6, admission analytics engine 108 determines one or more preventable admissions evaluations, which indicate how likely a patient 102 of a health care provider 104 is to be admitted to an inpatient facility for a health problem that might have been resolved with timely intervention by the health care provider 104. As described in relation to FIG. 7, admission analytics engine 108 may further assign accountability for some preventable admissions to health care provider 104 and generate a report to health care organization 106 or to health care provider 104 based on the one or more preventable admissions evaluations for the health care provider 104. In some implementations, admission analytics engine 108 may also or alternatively perform similar analysis for unnecessary admissions, inpatient admissions for health problems that may be treated outside of an inpatient facility.

Admission analysis system 100 evaluates health care providers 104 on the basis of how likely their patients 102 are to be admitted to an inpatient treatment facility for a problem that might have been prevented by an earlier medical intervention. Health care organization 106 provides medical records collected from health care providers 104 to admission analytics engine 108, which parses the medical record information to identify preventable admissions, generate reports on preventable admissions evaluations of health care providers 104, and determine health care providers accountable for preventable admissions. Admission analysis system 100 may also or alternatively identify unnecessary admissions and evaluate health care providers 104 based on their association with unnecessary admissions.

### Admissions Analytics Engine

FIG. 2 is an illustrative block diagram of an admissions analytics engine 200, which may act as the engine 108 of FIG. 1. Admissions analytics engine 200 evaluates health care provider performance based on medical records, which may be received from a health care provider 104, health care organization 106, or some other suitable source of information. Admission analytics engine 200 may send and receive data through a network 202, a computer network that in certain implementations may be the Internet. Admission analytics engine 200 connects to network 202 through communication port 204. A communication processor 206 may store received medical records in an aggregate patient information database 208. Evaluator 210 may process the medical records stored in database 208 to identify index admissions, and, based on the identified index admissions and the rules provided by the diagnostic map 212, calculate one or more unnecessary or preventable admissions evaluations for health care providers 104. Evaluator 210 may further identify an accountable health care provider for one or more unnecessary or preventable admissions based on the rules provided by diagnostic map 212 and the calculated unnecessary and preventable admissions evaluations, and may store evaluations and accountability information in provider database 214. Report generator 216 may generate a report regarding one or more health care providers 104 based on the information stored in provider database 214, and may provide such reports to communication processor 206 to transmit to health care organization 106 or health care providers 104.

The depicted communication port 204 is a network port which sends and receives data via network 202, which may include user commands, medical records, reports regarding a health care provider 104, or other suitable data. Communication port 204 may include a 100BASE-TX port, a 1000BASE-T port, a 10GBASE-T port, a Wi-Fi antenna, a cellular antenna, or other suitable network ports. In certain implementations, there may be a different number of ports than are depicted. In certain implementations, communication port 204 may provide secure communications, such as by using the Secure Sockets Layer (SSL) protocol, the Transport Layer Security (TLS) protocol, or other suitable protocol.

Communication processor 206 may be a computer processor that routes data through communication port 204, such as medical records and instructions sent by health care organization 106, and reports sent to health care organization 106. Communication processor 206 stores medical records sent by health care organization 106 in aggregate patient information database 208. In some implementations, such medical records may be anonymized, such that related medical records may be identified without identifying the patient associated with the medical record. In some implementations, communication processor 206 may also or alternatively receive medical records from a health care provider 104. Communication processor 206 may further act on commands sent by health care organization 106, such as modifying diagnostic map 212, instructing report generator 216 to generate a report regarding one or more health care providers, or otherwise fulfilling user instructions. Communication processor may also route reports or other evaluation information to health care organization 106, or, in some implementations, health care provider 104.

Aggregate patient information database 208 may be a computer-readable and -writable medium storing information regarding patients' clinical histories. Referring to FIG. 1, a patient's clinical history may include records of interactions by a patient 102 with one or more health care providers 104, such as check-ups, prescriptions, tests, surgeries, or other suitable interactions. In some implementations, a patient's clinical history may also include other biographical information regarding the patient, such as the patient's age, gender, smoking history, or other suitable medical information. Events in a clinical history may be represented by an interaction code, a string of characters representing a diagnosis of a patient's medical problems, treatment received by the patient, or another indicator of medical issues associated with a patient's interaction with a health care provider.

Evaluator 210 may be a computer processor that associates preventable and unnecessary admissions in aggregate patient information database 208 with health care providers 104 in order to generate unnecessary and preventable admissions evaluations for health care providers 104 and assign accountability for unnecessary and preventable admissions. As described in relation to FIGS. 5 and 6, evaluator 210 may identify index admissions in aggregate patient information database 208 and extract one or more interaction codes or other health information from health records associated with identified index admissions. Evaluator 210 may extract interaction codes or other health information using natural language processing, by searching for a predetermined set of codes, by extracting text to the right of the string “code:”, or by other suitable means. Evaluator 210 may compare extracted health information to diagnostic map 212 to further identify whether an index admission is an unnecessary or a preventable admission, and, if the index admission is unnecessary or preventable, which type or types of health care providers 104 are likely to have been associated with the index admission. By searching the clinical records associated with a time period preceding an index admission for the patient's interactions with any of the types of health care providers 104 likely to have been associated with the index admission, evaluator 210 may identify which health care providers 104 are associated with preventable or unnecessary admissions. Evaluator 210 may generate unnecessary or preventable admission evaluations for a health care provider 104 based on the number of unnecessary or preventable admissions associated with the health care provider 104. Evaluator 210 may further identify a health care provider 104 accountable for an unnecessary or preventable admission by comparing diagnostic map 212's indication of which type of health care provider is most likely to be responsible for an index admission to the unnecessary and preventable admission evaluations for the candidate health care providers. As an illustrative example, if diagnostic map 212 indicates that most hospitalizations for pneumonia would have been prevented by a primary care physician providing a flu immunization, but the primary care physician associated with a pneumonia hospitalization has an excellent immunization-related preventable admission evaluation, evaluator 210 may identify a second physician as more likely to have failed to provide the care that might have prevented the pneumonia hospitalization. Evaluator 210 may store the generated evaluations and accountability identifications in provider database 214.

Diagnostic map 212 may be a computer-readable and -writable medium storing information translating an interaction code or set of interaction codes associated with an index admission into an indication of whether the admission was preventable or unnecessary, and may be based on clinical criteria. Diagnostic map 212 may also indicate which types of health care provider 104 may be responsible for preventable or unnecessary admissions and a responsibility-based hierarchy of accountability for each preventable or unnecessary admission. As an illustrative example, cardiologists may tend to be the health care providers most responsible for a preventable heart-related admission, but diagnostic map 212 may also indicate that primary care physicians are also partially responsible. In such an example, a cardiologist may be most likely to be designated accountable for a preventable heart-related admission, but a primary care physician may be designated accountable under some circumstances.

Diagnostic map 212 may further provide time windows for preventable admissions, indicating when an intervention that might have prevented the admission should have taken place. Health care providers who were not associated with, or in some implementations did not interact with, the patient during the time window may not be considered responsible for the preventable admission. As an illustrative example, a physician who saw a patient one month before a preventable admission might be partially responsible for the admission, but a physician who last saw the patient three years before the admission may not be. Such time windows may be of a uniform length, or may vary based on the interaction code.

Diagnostic map 212 may further indicate how to take preventable admission evaluations into account in assigning responsibility for a preventable admission. As an illustrative example, if a patient has a preventable admission that normally would have been prevented with a vaccination provided by their primary care physician, but their primary care physician has a strong vaccination-related preventable admission evaluation, the preventable admission may be ascribed to a second, otherwise less likely cause associated with a second health care provider. In some implementations, diagnostic map 212 may provide one or more formulas for adjusting responsibilities based on preventable admission evaluations, which may include treating identified responsibilities as probabilities and making Bayesian adjustments to responsibilities based on preventable admission evaluations. In such implementations, accountability may be assigned based on which health care provider has the highest adjusted responsibility for the admission. In some implementations, the indicated adjustments may be in the form of evaluation thresholds, indicating ranges of preventable admission evaluations in which accountability for a corresponding preventable admission may or may not be assigned to a health care provider.

In implementations in which diagnostic map 212 provides thresholds, each threshold may be specific to both a preventable admission and each type of health care provider responsible for the preventable admission. In some implementations, a health care provider with a preventable admission evaluation below a threshold may not be found accountable for a preventable admission corresponding to the threshold. In such implementations, the threshold may be smaller for a type of health care provider that bears a larger responsibility for a variety of preventable admission. In some implementations, a health care provider with a preventable admission evaluation above a threshold may be found accountable for a corresponding preventable admission even if a different type of health care provider would typically otherwise be found accountable for the preventable admission. Thresholds may be based on clinical indicators, or may be based on the performance of similar health care providers, such as the average, standard deviation, median, or median absolute deviation of preventable admission evaluations for similar health care providers.

Diagnostic map 212 may also or alternatively provide a similar indication of which types of health care providers 104 are more or less responsible for unnecessary admissions. Time windows for unnecessary admissions may differ based on the variety of unnecessary admission. Diagnostic map 212 may indicate how to assign accountability for an unnecessary admission in the same way that diagnostic map 212 indicates how to assign accountability for a preventable admission, which may include providing rules for adjusting responsibility or assigning accountability based on unnecessary admission evaluations.

Provider database 214 may be a computer-readable and -writable medium storing information regarding health care providers 104, which may include the type of the health care provider 104, which patients 102 are associated with each health care provider 104, one or more unnecessary or preventable admission evaluations associated with each health care provider 104, the number of preventable or unnecessary admissions for which each health care provider 104 is responsible, or other suitable information.

Report generator 216 may be a computer processor that generates reports regarding one or more health care providers 104 indicated in provider database 214, in some implementations providing a report regarding all health care providers 104 associated with a health care organization 106. Report generator 216 may generate reports based on predetermined criteria, which may include receipt of a report request from a health care organization 106 or a health care provider 104, passage of a predetermined period of time, processing of a predetermined number of patient clinical histories, a worsening of a health care provider's preventable or unnecessary admission evaluation, or other suitable criteria. Reports may indicate the preventable or unnecessary admission evaluation of a health care provider 104 in one or more categories, a comparison between similar health care providers, suggestions for improving poor preventable or unnecessary admission evaluations, an indication of how many preventable or unnecessary admissions a health care provider 104 is accountable for, or other suitable information. A report may include a spreadsheet, a document, a chart, or other suitable content. Report generator 216 transmits such generated reports to communication processor 206 for routing to the health care organization 106 or some other suitable recipient.

Admission analytic engine 200 analyzes clinical histories received from a health care organization 106 to identify unnecessary or preventable inpatient admissions and evaluate associated health care providers 104 accordingly. Clinical histories are received via network 202 at communication port 204, and stored in aggregate patient information database 208 by communication processor 206. Evaluator 210 identifies unnecessary and preventable admissions and the health care providers associated therewith from the records in database 208 based on the rules of diagnostic map 212. The resulting unnecessary and preventable admissions evaluations are stored in provider database 214, and serve both to identify the health care provider 104 responsible for each preventable or unnecessary admission and for report generator 216 to generate reports presenting the health care provider evaluations.

### Diagnostic Map

FIG. 3 is a chart illustrating an interaction code translation chart 300, which may be an exemplary diagnostic map 212 of FIG. 2. Chart 300 relates the health problems associated with an index admission to information identifying health care providers. As depicted, chart 300 represents the health problems associated with index admissions as one or more interaction code sets 302. Chart 300 provides admission classifications 304 for index admissions according to their interaction code sets 302, thereby indicating whether an admission for a health problem associated with a particular interaction code set is unnecessary, preventable, or appropriate. In some implementations, an admission may be both unnecessary and preventable. Chart 300 also indicates which clinical processes 306 are likely associated with a failure to prevent an unnecessary or preventable admission, the probability of causal connection 308 between the health problem represented by an interaction code set 302 and a corresponding failure of a clinical process 306, and the health care provider types 310 associated with a clinical process 306. The responsibility share 312 is based on the amount of risk of a preventable or unnecessary admission that may be controlled by health care providers, and represents the proportion of that risk that may be controlled by a provider of health care provider type 310. As depicted, responsibility share 312 may be based on the probability of causal connection 308 and the control of the provider type 310 over the associated clinical process 306. Thus, the responsibility shares 312 for an unnecessary or preventable admission associated with an interaction code set 302 sum to 100%. In some implementations, responsibility share 312 may not specify each health care provider's explicit proportion of responsibility, but instead rank provider types 310 responsible for a clinical process 306 by how responsible each provider type 310 is for the clinical process 306. In some such implementations, responsibility share 312 may provide a hierarchy of responsibility for a clinical process 306, enabling assignment of accountability for a preventable or unnecessary admission to a health care provider as described in relation to FIG. 7. Threshold 314 indicates the range of a preventable or unnecessary admission evaluation associated with a clinical process 306 in which a health care provider may be assigned accountability for a preventable or unnecessary admission. Time window 316 in which a health care provider may be associated with an unnecessary or preventable admission. In some implementations, there may be a different number of interaction code sets 302 than are depicted, and an interaction code set 302 may have a different number of associated clinical processes 306, health care provider types 310, or time windows 316 than are depicted.

Relationships between one or more categories of chart 300 may be clinically derived. As an illustrative example, both an interaction code indicating a diabetes-related amputation and a set of interaction codes indicating, respectively, an amputation, a diabetic patient, and nerve damage may both be related to the same admission classification 304, the same set of health care clinical processes 306, and so on. Such relationships may be derived or updated by surveying one or more health care providers, through natural language processing of medical literature such as textbooks or journals, or by other suitable means. In some implementations, relationships between one or more categories of chart 300 may be derived from evidence-based medicine. As an illustrative example, evidence-based medicine may indicate a clinical process 306 mitigates the risk of a preventable admission, from which a probability of causal connection 308, a health care provider type 310, a responsibility share 312, a threshold 314, and a time window 316 may be derived.

As depicted, chart 300 lists three varieties of health problems associated with an index admission. The first health problem may be represented by either interaction code set 318a or interaction code 318b, while the second and third health problems are respectively represented by interaction codes 318c and 318d. An index admission associated with either interaction code 318b or the interaction codes of interaction code set 318a would be identified as preventable. Processes 320a, 320b, and 320c are identified as clinical processes that may have reduced the likelihood of the admission if carried out within, respectively, period 326a, 326b, or 326c, and process 320a is identified as having the largest effect on the risk of admission. Provider type 322c is responsible for process 320b and provider type 322d is responsible for process 320c. Provider types 322a and 322b are both responsible for carrying out process 320a, but provider type 322a is considered more responsible for carrying out process 320a than is provider type 322b. Such responsibility may be based on a comparison between providers of provider type 322a and providers of provider type 322b on the basis of the relative frequency with which each carries out process 320a, the relative frequency of errors in that part of process 320a under control of the respective provider types, or on some other suitable criteria. Thus, providers of provider type 322a or 322b who interacted with the patient within a period 326a of the preventable admission would be identified as responsible for the admission, as would providers of provider type 322c who interacted with the patient within period 326b of the admission and providers of provider type 322d who interacted with the patient within period 326c of the admission. As provider type 322a has the largest responsibility share 312 for the preventable admission, a provider of provider type 322a would be the first candidate for the provider accountable for such a preventable admission. But if the first candidate has a preventable admission evaluation that is associated with process 320a that is smaller than threshold 324a, the first candidate may not be accountable for the preventable admission. In such circumstances, a provider of provider type 322c has the next-largest responsibility share 312 for the preventable admission, and may be found accountable based on threshold 324c and the provider's preventable admission evaluation associated with process 320b.

As depicted, an index admission associated with interaction code 318c is marked as “unnecessary,” and only a provider of provider type 322e associated with the process 320d that led to the admission may be identified as the potentially responsible provider. Period 326d may include only the intervention itself, such as when a procedure associated with an index admission may be performed in outpatient facilities, or may include a time window, such as when a health care provider of provider type 322e orders an unnecessary procedure.

Interaction code 318d represents an appropriate admission, an index admission that is necessary and could not have been prevented with an appropriate health care intervention. As depicted, a provider type 322f may still be accountable for treatment of a patient admitted under interaction code 318d, but as the admission does not represent a health care provider's failure to provide appropriate care, interaction code 318d is not explicitly associated with any clinical process 306, probability of causal connection 308, responsibility shares 312, thresholds 314, nor time windows 316. As an illustrative example, interaction code 318d may represent an inpatient admission associated with an automobile accident without any complicating factors. In such an example, a hospital, an emergency room, or some other suitable health care provider may be considered accountable for patient care, but the admission may not have a negative effect on the health care provider's unnecessary or preventable admission evaluations.

### Computing Device

FIG. 4 is a block diagram of a computing device that can be used to implement or support the any of the components of the system of FIG. 1 or 2, and for performing any of the processes described herein. Admission analytics engine 200 may be implemented on one or more computing devices 400 having suitable circuitry, and health care organization 106 may communicate with admission analytics engine 108 through one or more computing devices 400 having suitable circuitry. In certain aspects, a plurality of the components of system 100 may be included within one computing device 400. In certain implementations, a component and a storage device may be implemented across several computing devices 400.

The computing device 400 comprises at least one communications interface unit, an input/output controller 410, system memory, and one or more data storage devices. This can support a network connection such as a connection to network 202 in FIG. 2. The system memory includes at least one random access memory (RAM 402) and at least one read-only memory (ROM 404). The memory 404 can support the content database 202 of FIG. 2, for example. All of these elements are in communication with a central processing unit (CPU 406) to facilitate the operation of the computing device 400. The computing device 400 may be configured in many different ways. For example, the computing device 400 may be a conventional standalone computer or alternatively, the functions of computing device 400 may be distributed across multiple computer systems and architectures. In FIG. 4, the computing device 400 may be linked, via network or local network, to other servers or systems.

The computing device 400 may be configured in a distributed architecture, wherein databases and processors are housed in separate units or locations. Some units perform primary processing functions and contain at a minimum a general controller or a processor and a system memory. In distributed architecture implementations, each of these units may be attached via the communications interface unit 408 to a communications hub or port (not shown) that serves as a primary communication link with other servers, client or user computers and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM and TCP/IP.

The CPU 406 comprises a processor, such as one or more conventional microprocessors and one or more supplementary co-processors such as math co-processors for offloading workload from the CPU 406. The CPU 406 is in communication with the communications interface unit 408 and the input/output controller 410, through which the CPU 406 communicates with other devices such as other servers, user terminals, or devices. The communications interface unit 408 and the input/output controller 410 may include multiple communication channels for simultaneous communication with, for example, other processors, servers or client terminals.

The CPU 406 is also in communication with the data storage device. The data storage device may comprise an appropriate combination of magnetic, optical or semiconductor memory, and may include, for example, RAM 402, ROM 404, flash drive, an optical disc such as a compact disc or a hard disk or drive. The CPU 406 and the data storage device each may be, for example, located entirely within a single computer or other computing device; or connected to each other by a communication medium, such as a USB port, serial port cable, a coaxial cable, an Ethernet cable, a telephone line, a radio frequency transceiver or other similar wireless or wired medium or combination of the foregoing. For example, the CPU 406 may be connected to the data storage device via the communications interface unit 408. The CPU 406 may be configured to perform one or more particular processing functions.

The data storage device may store, for example, (i) an operating system 412 for the computing device 400; (ii) one or more applications 414 (e.g., computer program code or a computer program product) adapted to direct the CPU 406 in accordance with the systems and methods described here, and particularly in accordance with the processes described in detail with regard to the CPU 406; or (iii) database(s) 416 adapted to store information that may be utilized to store information required by the program. The depicted database 416 can be any suitable database system, including the commercially available Microsoft Access database, and can be a local or distributed database system. The design and development of suitable database systems are described in McGovern et al., A Guide To Sybase and SQL Server, Addison-Wesley (1993).

The operating system 412 and applications 414 may be stored, for example, in a compressed, an uncompiled and an encrypted format, and may include computer program code. The instructions of the program may be read into a main memory of the processor from a computer-readable medium other than the data storage device, such as from the ROM 404 or from the RAM 402. While execution of sequences of instructions in the program causes the CPU 406 to perform the process steps described herein, hard-wired circuitry may be used in place of, or in combination with, software instructions for implementation of the processes of the present disclosure. Thus, the systems and methods described are not limited to any specific combination of hardware and software.

Suitable computer program code may be provided for performing one or more functions in relation to evaluating health care provider performance as described herein. The program also may include program elements such as an operating system 412, a database management system and “device drivers” that allow the processor to interface with computer peripheral devices (e.g., a video display, a keyboard, a computer mouse, etc.) via the input/output controller 410.

The term “computer-readable medium” as used herein refers to any non-transitory medium that provides or participates in providing instructions to the processor of the computing device 400 (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer can read.

Various forms of computer readable media may be involved in carrying one or more sequences of one or more instructions to the CPU 406 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device 400 (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

As discussed above, a function relating to presenting content can be realized as a software component operating on a conventional data processing system such as a Unix workstation. In that implementation, the function can be implemented as a C language computer program, or a computer program written in any high level language including C++, Fortran, Java or BASIC. See The C++ Programming Language, 2nd Ed., Stroustrup Addision-Wesley. Additionally, in an implementation where microcontrollers or DSPs are employed, the function relating to presenting content can be realized as a computer program written in microcode or written in a high level language and compiled down to microcode that can be executed on the platform employed. The development of such network traffic control systems is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing. Developing code for the DSP and microcontroller systems follows from principles well known in the art.

Some implementations of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some implementations may also be implemented by the preparation of application-specific integrated circuits or by interconnecting an appropriate network of conventional component circuits, as will be readily apparent to those skilled in the art. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some implementations include a computer program product comprising a computer readable medium (media) having instructions stored thereon/in and, when executed (e.g., by a processor), perform methods, techniques, or implementations described herein, the computer readable medium comprising sets of instructions for performing various steps of the methods, techniques, or implementations described herein. The computer readable medium may comprise a storage medium having instructions stored thereon/in which may be used to control, or cause, a computer to perform any of the processes of an implementation. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in. Additionally, the storage medium may be a hybrid system that stored data across different types of media, such as flash media and disc media. Optionally, the different media may be organized into a hybrid storage aggregate. In some implementations different media types may be prioritized over other media types, such as the flash media may be prioritized to store data or supply data ahead of hard disk storage media or different workloads may be supported by different media types, optionally based on characteristics of the respective workloads. Additionally, the system may be organized into modules and supported on blades configured to carry out the storage operations described herein.

Stored on any one of the computer readable medium (media), some implementations include software instructions for controlling both the hardware of the general purpose or specialized computer or microprocessor, and for enabling the computer or microprocessor to interact with a human user and/or other mechanism using the results of an implementation. Such software may include without limitation device drivers, operating systems, and user applications. Ultimately, such computer readable media further includes software instructions for performing implementations described herein. Included in the programming (software) of the general-purpose/specialized computer or microprocessor are software modules for implementing some implementations.

### Population-Centric Initial Evaluation

FIG. 5 is an illustrative flow chart of a population-centric evaluation process 500. Population-centric evaluation process 500 identifies preventable and unnecessary admissions evaluations for health care providers based on the treatment records of patients who received care from the health care providers. Referring to FIG. 2, population-centric evaluation process 500 begins with step 501, in which communication processor 206 receives patient treatment records and stores them in aggregate patient information database 208. Patient treatment records may include physician diagnoses, consultations with paramedics, consultations with other health professionals, prescribed prescriptions, filled prescriptions, referrals, test results, admissions records, procedure records, durable medical equipment orders, insurance claims submitted by health care providers, insurance claims submitted by patients, lists of scheduled appointments, demographic information, socioeconomic status, or other suitable records, and may be received from one or both of a health care provider 104 and a health care organization 106. In some implementations, patient treatment records are received in response to a request transmitted to appropriate health care providers 104 and health care organizations 106.

In step 502, evaluator 210 identifies a health care provider 104 associated with one or more of the treatment records. A health care provider 104 may be associated with a treatment record by having generated or edited the treatment record, by having submitted or received payment for a claim, by being listed on the treatment record, by being a primary care physician of a patient associated with the treatment record, or based on some other suitable indication. Step 502 may be carried out in response to communication processor 206 storing the patient treatment records, to communication processor 206 storing a predetermined number of patient treatment records, or based on some other suitable criteria. In step 503, evaluator 210 further identifies each patient indicated on treatment records associated with the identified health care provider 104 identified in step 502, and thereby identifies patients associated with the identified health care provider 104.

In step 504, evaluator 210 identifies index admissions associated with the identified patients. Evaluator 210 may carry out step 504 by filtering the patient treatment records for treatment records listing a patient identified in step 503 and meeting predetermined characteristics of an index admission. Such predetermined characteristics may include whether the treatment record bears an admissions identifier, whether the treatment record is associated with an inpatient treatment facility, whether the treatment record was generated less than a predetermined period after the generation of another inpatient treatment record, whether the patient associated with the treatment record died within a predetermined period following the index admission, whether the patient associated with the treatment record has a medical history with a health care provider 104 or health care organization 106 longer than a predetermined length of time, whether the index admission is part of a case rate agreement, or other suitable characteristics. Having identified the index admissions associated with patients associated with the health care provider identified in step 502, evaluator 210 may then identify the unnecessary and preventable admissions associated with the health care provider.

In step 505, evaluator 210 identifies unnecessary admissions associated with the identified health care provider 104 by applying the rules of diagnostic map 212 to each index admission identified in step 504. Applying the rules occurs in two parts: identifying whether the index admission is unnecessary, and, if so, identifying whether the identified health care provider 104 is associated with the unnecessary admission. In the first part, evaluator 210 searches the patient treatment record listing the index admission for one or more interaction codes or other suitable information suggesting or identifying a health problem. Evaluator 210 then searches diagnostic map 212 for an entry matching the extracted information, and determines whether the matching entry indicates that the index admission was unnecessary. If the admission was unnecessary, evaluator 210 extracts criteria for identifying one or more health care providers 104 associated with the unnecessary admission from the entry in diagnostic map 212. Such criteria may include whether the identified health care provider 104 is associated with the patient treatment record listing the index admission, whether the identified health care provider 104 is associated with a treatment record matching a patient identifier, generated within a period preceding the unnecessary admission, and associated with the health problem associated with the unnecessary admission, or other suitable criteria. As an illustrative example, if a patient has an unnecessary admission for colonoscopy, diagnostic map 212 may indicate that the admitting hospital, the admitting gastroenterologist, and the primary care physician who referred the patient for the colonoscopy may be associated with the unnecessary admission. If the identified health care provider 104 meets the criteria provided by diagnostic map 212, evaluator 210 identifies the unnecessary admission as being associated with the identified health care provider 104. If the provider does not meet the criteria, the provider is not identified as being associated with the unnecessary admission even though the provider is associated with the patient who was unnecessarily admitted.

Step 506, in which evaluator 210 identifies preventable admissions associated with the identified health care provider 104, is similar to step 505. Evaluator 210 again applies the rules of diagnostic map 212 to each index admission identified in step 504 in two parts: identifying whether the index admission was preventable, and, if so, identifying whether the identified health care provider 104 is associated with the unnecessary admission. In the first part, evaluator 210 searches the patient treatment record listing the index admission for one or more interaction codes or other suitable information suggesting or identifying a health problem. Evaluator 210 searches diagnostic map 212 for an entry matching the extracted information, and determines whether the matching entry indicates whether the index admission was preventable. If the index admission was preventable, evaluator 210 extracts criteria for identifying one or more health care providers 104 associated with the preventable admission from the same matching entry. Such criteria may include one or more types of health care providers, one or more medical specialties of health care providers, a time window for interactions with the patient (e.g., whether a health care provider saw the patient less than thirty days before the preventable admission), or other suitable criteria. Such criteria may be based on the types of health care providers who provide an element of care associated with controlling the health problem that gave rise to the preventable admission, which in turn may be based on published, evidence-based standards of care. If the identified health care provider 104 meets the criteria provided by diagnostic map 212, evaluator 210 identifies the preventable admission as being associated with the identified health care provider 104. As an illustrative example, if a patient is admitted to an inpatient treatment facility for a preventable heart attack and saw a first cardiologist three weeks earlier, a second cardiologist two years earlier, and a neurologist one week earlier, the preventable admission may only be associated with the first cardiologist even though the other physicians are also associated with the patient.

In step 507, evaluator 210 calculates and records at least one preventable admission evaluation for the identified health care provider. A preventable admission evaluation indicates how likely a health care provider's patient is to have an inpatient admission for a health problem that might have been resolved with an earlier intervention by the health care provider. A health care provider may have more than one preventable admission evaluation based on the varieties of preventable admissions the health care provider is associated with, and more than one variety of preventable admission may be associated with a type of preventable admission evaluation. As an illustrative example, a primary care physician may be associated with very few preventable admissions associated with failure to provide vaccinations, but may also be associated with a large number of preventable admissions associated with diabetes control. In such an example, the primary care physician may have a positive “preventative healthcare” preventable admission evaluation and a poor “chronic disease management” admission evaluation. For a type of preventable admission, a health care provider's preventable admission evaluation is a function of the number of preventable admissions related to the type of preventable admission and with which the health care provider is associated. The preventable admission evaluation may also be a function of the proportion of the population under the care of the health care provider, the number of patients associated with the health care provider, the number of patients of the health care provider with similar health problems, the number of necessary, unpreventable admissions associated with the health care provider, or some other suitable numbers. In some implementations, the calculation of a preventable admission evaluation may weight preventable admissions by how recently the preventable admission occurred, by the probability that the identified health care provider was responsible for the preventable admission, by the disease burden of the population associated with the health care provider, by the preventable admission evaluation of similar health care providers, or by other suitable criteria.

In step 508, like in step 507, evaluator 210 calculates and records at least one unnecessary admission evaluation for the identified health care provider, but based on unnecessary admissions rather than preventable admissions. Like a preventable admission evaluation, an unnecessary admission evaluation indicates how likely a health care provider is to be associated with an unnecessary admission. A health care provider may have more than one unnecessary admission evaluation based on the varieties of unnecessary admissions the health care provider is associated with, such as a hospital having one unnecessary admission evaluation associated with patients healthy enough to be treated in outpatient facilities, and a second unnecessary admission evaluation associated with patients admitted for lack of outpatient treatment facilities. A health care provider's unnecessary admission evaluation for a type of unnecessary admission may be a function of the number of unnecessary admissions of the type, the number of patients or proportion of the population associated with the health care provider, the number or proportion of patients of the health care provider with similar health problems, the number of necessary, unpreventable admissions associated with the health care provider, a measurement of the availability of other forms of emergency or urgent care, rates of preventative therapy within a population, demographics of the health care provider's patients, or some other suitable numbers. In some implementations, the calculation of an unnecessary admission evaluation may weight unnecessary admissions by how recently the unnecessary admission occurred, by the probability that the identified health care provider was responsible for the unnecessary admission, by the disease burden of the population associated with the health care provider, by the unnecessary admission evaluation of similar health care providers, or by other suitable criteria.

Population-centric evaluation process 500 may end with step 509, in which evaluator 210 determines whether there are any further health care providers associated with the patient treatment records that have not yet been evaluated. If so, population-centric evaluation process returns to step 502; otherwise it ends. In some implementations, population-centric evaluation process 500 may not identify unnecessary admissions nor calculate unnecessary admission evaluations. In some implementations, population-centric evaluation process 500 may be followed by reporting and accountability assignment process 700, described in relation to FIG. 7.

In some implementations, more than one step of population-centric evaluation process 500 may be carried out in parallel. As an illustrative example, steps 505 and 506 may be accomplished with a single comparison of the index admission to diagnostic map 212.

### Admission-Centric Initial Evaluation

FIG. 6 is an illustrative flow chart of an admission-centric evaluation process 600. Like population centric evaluation process 500, admission-centric evaluation process 600 identifies preventable and unnecessary admissions evaluations for health care providers based on the patient treatment records, but focuses on admissions rather than providers. Referring to FIG. 2, admission-centric evaluation process 600 begins with step 601, in which communication processor 206 receives patient treatment records and stores them in aggregate patient information database 208. Patient treatment records may include physician diagnoses, consultations with paramedics, consultations with other health professionals, prescribed prescriptions, filled prescriptions, referrals, test results, admissions records, procedure records, durable medical equipment orders, insurance claims submitted by health care providers, insurance claims submitted by patients, lists of scheduled appointments, demographic information, socioeconomic status, or other suitable records, and may be received from one or both of a health care provider 104 and a health care organization 106. In some implementations, patient treatment records are received in response to a request transmitted to appropriate health care providers 104 and health care organizations 106.

In step 602, evaluator 210 identifies an index admission from the patient treatment records received in step 601. Evaluator 210 may carry out step 602 by filtering the patient treatment records for treatment records meeting predetermined characteristics of an index admission. Such predetermined characteristics may include whether the treatment record bears an admissions identifier, whether the treatment record is associated with an inpatient treatment facility, whether the treatment record was generated less than a predetermined period after the generation of another inpatient treatment record, whether the patient associated with the treatment record died within a predetermined period following the index admission, whether the patient associated with the treatment record has a medical history with a health care provider 104 or health care organization 106 longer than a predetermined length of time, whether the index admission is part of a case rate agreement, or other suitable characteristics.

In step 603, evaluator 210 identifies a patient clinical history for a period preceding the index admission that was identified in step 602. Evaluator 210 may identify the patient clinical history by filtering the patient treatment records received in step 601 to include only those treatment records associated with the patient with whom the index admission is associated. The length of the period may vary based on the health problem associated with the index admission, or may be uniform across index admissions. In the former implementation, the length of the period may be indicated by diagnostic map 212. The patient clinical history may be used to determine which health care providers are associated with the index admission.

In step 604, evaluator 210 determines if the index admission was necessary by applying the rules of diagnostic map 212 to the index admission. Evaluator 210 searches the patient treatment record listing the index admission for one or more interaction codes or other suitable information suggesting or identifying a health problem. Evaluator 210 then searches diagnostic map 212 for an entry matching the extracted information, and determines whether the matching entry indicates that the index admission was necessary. If not, evaluator 210 may further extract criteria for identifying one or more health care providers 104 associated with the unnecessary admission from the entry in diagnostic map 212. Such criteria may include whether a health care provider 104 is associated with the patient treatment record listing the index admission, whether the identified health care provider 104 is associated with a treatment record matching a patient identifier, generated within a period preceding the unnecessary admission, and associated with the health problem associated with the unnecessary admission, or other suitable criteria. Admission-centric evaluation process 600 then proceeds to step 605, in which evaluator 210 filters the patient clinical history identified in step 603 using the extracted criteria to identify one or more health care providers associated with the unnecessary admission.

In step 606, evaluator 210 calculates or recalculates one or more unnecessary admission evaluations of the health care providers identified in step 605. An unnecessary admission evaluation indicates how likely a health care provider is to be associated with an unnecessary admission. A health care provider may have more than one unnecessary admission evaluation based on the varieties of unnecessary admissions the health care provider is associated with, such as a hospital having one unnecessary admission evaluation associated with patients healthy enough to be treated in outpatient facilities, and a second unnecessary admission evaluation associated with patients admitted for lack of outpatient treatment facilities. A health care provider's unnecessary admission evaluation for a type of unnecessary admission may be a function of the number of unnecessary admissions of the type, the number of patients or proportion of the population associated with the health care provider, the number or proportion of patients of the health care provider with similar health problems, the number of necessary, unpreventable admissions associated with the health care provider, a measurement of the availability of other forms of emergency or urgent care, rates of preventative therapy within a population, demographics of the health care provider's patients, or some other suitable numbers. In some implementations, the calculation of an unnecessary admission evaluation may weight unnecessary admissions by how recently the unnecessary admission occurred, by the probability that the identified health care provider was responsible for the unnecessary admission, by the disease burden of the population associated with the health care provider, by the unnecessary admission evaluation of similar health care providers, or by other suitable criteria.

If, in step 604, evaluator 210 determines that the index admission was necessary, then step 604 is followed by step 607. In step 607, evaluator 210 determines whether the admission was preventable by applying the rules of diagnostic map 212 to the index admission. Evaluator 210 searches diagnostic map 212 for an entry matching the extracted information, and determines whether the matching entry indicates that the index admission was preventable. If the admission was preventable, evaluator 210 further extracts criteria for identifying one or more health care providers 104 associated with the preventable admission from the entry in diagnostic map 212, and admission-centric evaluation process 600 will proceed to step 608. The extracted criteria may include one or more types of health care providers, one or more medical specialties of health care providers, a time window for interactions with the patient (e.g., whether a health care provider saw the patient less than thirty days before the preventable admission), or other suitable criteria. In step 608, evaluator 210 filters the patient clinical history identified in step 603 using the extracted criteria to identify one or more health care providers associated with the preventable admission. In some implementations, if no records are left in the patient clinical history after the filtering of step 608, evaluator 210 may designate the index admission as unpreventable.

In step 609, evaluator 210 calculates or recalculates one or more preventable admission evaluations of the health care providers identified in step 608. A preventable admission evaluation indicates how likely a health care provider's patient is to have an inpatient admission for a health problem that might have been resolved with an earlier intervention by the health care provider. A health care provider may have more than one preventable admission evaluation based on the varieties of preventable admissions the health care provider is associated with, and more than one variety of preventable admission may be associated with a type of preventable admission evaluation. As an illustrative example, a primary care physician may be associated with very few preventable admissions associated with failure to provide vaccinations, but may also be associated with a large number of preventable admissions associated with diabetes control. In such an example, the primary care physician may have a positive “preventative healthcare” preventable admission evaluation and a poor “chronic disease management” admission evaluation. For a type of preventable admission, a health care provider's preventable admission evaluation is a function of the number of preventable admissions related to the type of preventable admission and with which the health care provider is associated. The preventable admission evaluation may also be a function of the proportion of the population under the care of the health care provider, the number of patients associated with the health care provider, the number of patients of the health care provider with similar health problems, the number of necessary, unpreventable admissions associated with the health care provider, or some other suitable numbers. In some implementations, the calculation of a preventable admission evaluation may weight preventable admissions by how recently the preventable admission occurred, by the probability that the identified health care provider was responsible for the preventable admission, by the disease burden of the population associated with the health care provider, by the preventable admission evaluation of similar health care providers, or by other suitable criteria.

If the index admission identified in step 602 was unpreventable, or if admission-centric evaluation process 600 has completed steps 606 or 609, admission-centric evaluation process 600 continues to step 610, in which evaluator 210 searches the set of patient treatment records for any further index admissions not already classified during admission-centric evaluation process 600. If there are any such index admissions, admission-centric evaluation process 600 returns to step 602; otherwise, process 600 may end. In some implementations, population-centric evaluation process 600 may not identify unnecessary admissions nor calculate unnecessary admission evaluations, in which case steps 605 and 606 are skipped.

In some implementations, more than one step of admission-centric evaluation process 600 may be carried out in parallel. As illustrative examples, steps 604 and 607 may be accomplished with a single comparison of the index admission to diagnostic map 212. In some implementations, an admission may be both unnecessary and preventable. In such implementations, step 606 may be followed by step 607, or, if steps 604 and 607 are carried out in parallel, steps 605 and 608 may be carried out in parallel, as may be steps 606 and 609.

### Reporting and Accountability Assignment Process

FIG. 7 is an illustrative flow chart of a reporting and accountability assignment process 700. Process 700 assigns accountability for preventable admissions based on the associations between health care providers and preventable admissions identified by process 500 or 600 and the preventable admission evaluations generated in process 500 or 600. Process 700 may assign accountability for a preventable admission to a first health care provider associated with the preventable admission and of a health care provider type most likely responsible for not preventing the preventable admission. But process 700 may assign accountability to a different provider if the first provider has a preventable admissions evaluation strong enough to suggest that, in this case, a different provider is more likely to be responsible for the preventable admission. While process 700 may designate a single provider as accountable for a preventable admission, association with a preventable admission may indicate a provider's co-responsibility for the preventable admission, and co-responsibility may be reflected in reports generated by process 700. For brevity, process 700 is depicted as assigning accountability for preventable admissions, but process 700 may also or alternatively be applied to assign accountability for unnecessary admissions.

Referring to FIG. 2, process 700 begins with step 701, in which evaluator 210 identifies both a preventable admission and health care providers associated therewith, as described in relation to FIG. 5 or 6. In step 702, evaluator 210 identifies a first candidate for the accountable provider for the preventable admission identified in step 701. Step 702 is carried out by comparing the health care providers associated with the preventable admission based on their responsibilities as indicated by diagnostic map 212. The entry in diagnostic map 212 associated with a preventable admission indicates which types of health care providers have the greatest influence on the risk of such a preventable admission occurring. Such health care providers thus have the greatest responsibility for such a preventable admission. As an illustrative example, neurologists may have the largest effect on the likelihood of a patient having a preventable admission for stroke and cardiologists the second largest effect. Thus neurologists would be considered most responsible for failure to prevent unnecessary admission for stroke, and cardiologists second most responsible. Evaluator 210 may identify the first candidate for the accountable health care provider as that health care provider that is associated with the preventable admission and of a type most responsible for such preventable admissions.

Referring to FIG. 3, in step 703 evaluator 210 identifies a threshold 314 associated with both the preventable admission and the first candidate's health care provider type, e.g., whether the first candidate is a cardiologist, a group practice, a hospital, a testing facility, an imaging lab, or some other suitable health care provider type. A preventable admission evaluation threshold represents a threshold for assigning accountability: if one candidate for the accountable health care provider has a preventable admission evaluation below the threshold, a second health care provider may be identified as accountable for the preventable admission even though the first health care provider is typically otherwise considered more responsible for the preventable admission. The threshold, like the preventable admission evaluation, may be specific to the interaction code or set of interaction codes associated with the admission, the intervention associated with the health care provider that might have prevented the preventable admission, or to some other suitable characteristic of the admission. As an illustrative example, if a patient's preventable admission relates to a colostomy to treat advanced colon cancer, the patient's oncologist, gastroenterologist, and primary care physician all may have some responsibility for the colostomy. The oncologist may be the first candidate for the accountable health care provider position, but if the oncologist has a very strong preventable admissions evaluation associated with controlling cancer without the need for an inpatient admission, the gastroenterologist may be designated as accountable instead.

In step 704, evaluator 210 determines whether the candidate's evaluation is greater than the preventable admission threshold identified in step 703. If not, then, in step 705, evaluator 210 identifies a next candidate for the accountable provider and process 700 returns to step 703. Step 705 repeats step 702, but excludes the current candidate as a possible candidate. Otherwise, process 700 proceeds to step 706, in which evaluator 210 identifies the candidate last reviewed in step 704 as the accountable provider and records an indication of that accountability in provider database 214. In some implementations, rather than compare one or more candidates' preventable admission evaluation to thresholds, evaluator 210 may calculate a responsibility share for each associated health care provider based on each associated health care provider's provider type, each associated health care provider's preventable admission evaluation in a category appropriate to both the preventable admission and the provider's provider type, and an initial responsibility listed in diagnostic map 212 for each provider type associated with the preventable admission. In such implementations, accountability is assigned to the health care provider with the highest adjusted responsibility for the preventable admission.

In step 707, evaluator 210 determines whether any preventable admissions remain unchecked in the records. If so, process 700 returns to step 701; otherwise, process 700 ends with step 708, in which report generator 216 generates a report regarding one or more providers listing one or more of the providers' evaluations stored in provider database 214. The report of step 708 may indicate which preventable admissions a health care provider is accountable for, the health care provider's preventable admissions evaluations, how the health care provider's preventable admissions compare to similar health care providers, or other suitable information.

### Sample Report

FIG. 8 depicts an exemplary screenshot of a report 800. Referring to FIG. 7, report 800 may be generated by process 700. As depicted, report 800 presents charts 802A, 802B, and 802C (collectively, charts 802), and a recommendation 804. Each chart 802 presents a preventable or unnecessary admission evaluation in a category for each health care provider in a set of health care providers in a category. A preventable or unnecessary admission evaluation in a category is an evaluation of a health care provider on the basis of a category of preventable or unnecessary admissions. Categories of preventable admissions may include preventable admissions associated with medication review, patient failure to adhere to a medication regime, patient behavioral issues, care coordination by the health care provider, monitoring and evaluation of long-term health conditions, optimization of long-term health condition treatment, medical screening, immunizations, or other suitable categories. Categories of unnecessary admissions may include unnecessary admissions associated with procedures not necessary to address a health problem, procedures that may be handled outside of the inpatient setting, or other suitable categories. As depicted, chart 802A shows preventable admission evaluations for a set of health care providers based on admissions associated with failures in medication adherence and persistence; chart 802B shows preventable admission evaluations associated with behavioral lifestyle processes; and chart 802C shows preventable admission evaluations associated with evaluation and monitoring of patients. Recommendation 804 is based on the evaluations shown in charts 802, and highlights an area for improvement by one practice and a possible explanatory factor for the strong evaluations of another practice. As depicted, the higher the preventable or unnecessary admissions evaluation in a category for a health care provider, the more likely the health care provider is to have problems providing health care processes related to the category. Health care providers with preventable or unnecessary admissions evaluations significantly different from those of otherwise similar health care providers may differ from the other health care providers in how they provide clinical processes, in the patient population they serve, in the resources they have available, or in some other suitable fashion.

### Alternative Implementations

While various implementations of the present disclosure have been shown and described herein, it will be obvious to those skilled in the art that such implementations are provided by way of example only. Numerous variations, changes, and substitutions will now occur to those skilled in the art without departing from the disclosure. Examples include associating health care provider types with preventable admissions through statistical analysis, identifying readmissions as unnecessary or preventable admissions, and assigning co-accountability for a preventable or unnecessary admission to more than one responsible provider. In the last example, co-accountability may be to each provider based on each responsible provider's share of responsibility for the admission as depicted in relation to FIG. 3, may be assigned equally to each health care provider associated with that process with the highest probability of causal connection to the admission if none of the providers have a corresponding evaluation below the corresponding threshold, or in some other suitable fashion. It should be understood that various alternatives to the implementations of the disclosure described herein may be employed in practicing the disclosure. An implementation of the systems and methods described herein may be made independently of or combined with another implementation. It is intended that the following claims define the scope of the disclosure and that methods and structures within the scope of these claims and their equivalents be covered thereby.

The method of the present invention may be performed in either hardware, software, or any combination thereof, as those terms are currently known in the art. In particular, the present method may be carried out by software, firmware, or microcode operating on a computer or computers of any type. Additionally, software embodying the present invention may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, the present invention is not limited to any particular platform, unless specifically stated otherwise in the present disclosure.

We claim:

1. A computer-implemented method for evaluating health care provider performance, comprising:
receiving a set of inpatient treatment records;
identifying, based on the set of inpatient treatment records, a set of preventable admissions;
for each preventable admission in the set of preventable admissions:
identifying a clinical history associated with the preventable admission, wherein the clinical history for the preventable admission includes medical records associated with at least a predetermined period preceding the preventable admission,
identifying a set of health care providers from the clinical history based on one or more interaction codes associated with the preventable admission,
calculating a preventable admission evaluation for each health care provider in the set of health care providers based on the one or more interaction codes associated with the preventable admission, and
assigning accountability for the preventable admission to a health care provider based on the one or more associated interaction codes and the preventable admission evaluation of the health care provider; and
generating a report based on the preventable admission evaluation of each health care provider.

2. The method of claim 1, wherein the preventable admission evaluation of a health care provider is a function of the number of preventable admissions associated with a predetermined set of interaction codes.

3. The method of claim 1, wherein the set of health care providers associated with a preventable admission includes at least a first and a second health care provider, and further comprising:
in response to the first health care provider having a preventable admission evaluation greater than a threshold, assigning accountability for the preventable admission to the first provider; and
in response to the first health care provider having a preventable admission evaluation less than a threshold, assigning accountability for the preventable admission to the second provider.

4. The method of claim 3, wherein the threshold is based on a preventable admission evaluation of a health care provider in a set of health care providers similar to the first health care provider.

5. The method of claim 3, wherein the threshold is based on characteristics of a patient associated with the preventable admission.

6. The method of claim 1, wherein a health care provider is associated with more than one preventable admission evaluation.

7. The method of claim 1, wherein the report identifies a care measure associated with the preventable admission evaluation and the health care provider.

8. The method of claim 1, wherein the set of health care providers includes a physician.

9. The method of claim 1, wherein the set of health care providers includes a physician practice group.

10. The method of claim 1, wherein the set of health care providers includes a hospital.

11. The method of claim 1, wherein the one or more interaction codes includes diagnosis-related group (DRG) codes.

12. The method of claim 1, wherein the one or more interaction codes includes Ninth Revision International Classification of Diseases (ICD-9) codes.

13. A computer-implemented method for evaluating health care provider performance, comprising:
receiving a set of inpatient treatment records;
identifying, based on the set of inpatient treatment records, a set of unnecessary admissions;
for each unnecessary admission in the set of unnecessary admissions:
identifying a clinical history associated with the unnecessary admission, wherein the clinical history for the unnecessary admission includes medical records associated with at least a predetermined period preceding the unnecessary admission,
identifying a set of health care providers from the clinical history based on one or more interaction codes associated with the unnecessary admission, and
calculating an unnecessary admission evaluation for each health care provider in the set of health care providers based on the one or more interaction codes associated with the unnecessary admission;
assigning accountability for each unnecessary admission to a health care provider based on the one or more associated interaction codes and the unnecessary admission evaluation of the health care provider; and
generating a report based on the unnecessary admission evaluation of each health care provider.

14. A computer-implemented method for evaluating health care providers and generating a report of health care provider performance, comprising:
identifying a set of patients associated with a set of one or more health care providers;
receiving a set of treatment records associated with the set of patients;
identifying, based on the set of treatment records, a subset of patients that were admitted to an inpatient treatment facility within a predetermined period of receiving care associated with a health care provider of the set of health care providers;
filtering the subset of patients based on the set of treatment records to identify a set of preventable admissions associated with the set of health care providers, wherein each preventable admission in the set of preventable admissions is associated with one or more interaction codes;
calculating a preventable admissions evaluation for each health care provider in the set of health care providers based on the set of preventable admissions;
identifying an accountable health care provider for each preventable admission in the set of preventable admissions based on the one or more associated interaction codes and the preventable admissions evaluation of each health care provider in the set of health care providers; and
generating a report based on the preventable admissions evaluations of the set of health care providers.

15. A system for evaluating health care provider performance, comprising:
an aggregate patient information database for storing a set of medical records;
a diagnostic map for identifying relationships between at least one preventable admission and at least one health care provider associated with the preventable admission;
an evaluator for:
identifying a set of preventable admissions;
identifying, for each preventable admission in the set of preventable admissions, a clinical history associated with the preventable admission, wherein the clinical history associated with the preventable admission includes medical records associated with at least a predetermined period preceding the preventable admission,
identifying a set of health care providers from the clinical history based on one or more interaction codes associated with each preventable admission and the diagnostic map,
calculating a preventable admission evaluation for each health care provider in the set of health care providers based on the one or more interaction codes associated with the preventable admission, and
assigning accountability for each preventable admission to a health care provider based on the one or more associated interaction codes and the preventable admission evaluation of the health care provider;
a provider database for storing the preventable admission evaluation for each health care provider in the set of health care providers; and
a report generator for generating reports based on the preventable admission evaluation of each health care provider.

16. The system of claim 15, wherein the preventable admission evaluation of a health care provider is a function of the number of preventable admissions associated with a predetermined set of interaction codes.

17. The system of claim 15, wherein the set of health care providers associated with a preventable admission includes at least a first and a second health care provider, and wherein the evaluator is further configured to:
assign accountability for the preventable admission to the first health care provider in response to the first health care provider having a preventable admission evaluation greater than a threshold; and
assign accountability for the preventable admission to the second health care provider in response to the first health care provider having a preventable admission evaluation less than a threshold.

18. The system of claim 17, wherein the threshold is based on the preventable admission evaluation of a set of similar health care providers.

19. The system of claim 17, wherein the threshold is based on characteristics of a patient associated with the preventable admission.

20. The system of claim 15, wherein a health care provider is associated with more than one preventable admission evaluation.

21. The system of claim 15, wherein the report identifies a preventative care measure associated with the preventable admission evaluation and the health care provider.

22. The system of claim 15, wherein the set of health care providers includes a physician.

23. The system of claim 15, wherein the set of health care providers includes a physician practice group.

24. The system of claim 15, wherein the set of health care providers includes a hospital.
